(19) United States
(12) Patent Application Publication
(10) Pub. No.: US 2012/0259499 A1
(43) Pub. Date: Oct. 11, 2012

(54) VEHICLE STATE DETECTING DEVICE AND VEHICLE STATE DETECTING SYSTEM

(76) Inventor: Yuji Hiraoka, Tokyo (JP)

(21) Appl. No.: 13/516,513

(22) PCT Filed: Mar. 10, 2010
(86) PCT No.: PCT/JP2010/001707

§ 371 Date: Jun. 15, 2012

(51) Int. Cl. G01P 15/18

(52) U.S. Cl. 701/29.1

(57) ABSTRACT

A vehicle state detecting device in accordance with the present invention is provided with acceleration sensors 1, 2, and 3 respectively disposed on three axes in such a way as to be able to detect acceleration in each of directions of three axes, and an arithmetic operation unit 7 for determining a gravity direction from the sum of vectors which are results of detection acquired by the acceleration sensors respectively disposed on the three axes to correct a mounting inclination thereof with respect to a vehicle, and for detecting acceleration in a longitudinal direction of the vehicle, acceleration in a rightward or leftward direction of the vehicle, and acceleration in an upward or downward direction of the vehicle.

### FIELD OF THE INVENTION

The present invention relates to a vehicle state detecting device which detects a state of a vehicle such as a front collision or a side collision, and a vehicle state detecting system which detects a state of a vehicle such as a rollover or a sideslip, as well as a front collision or a side collision of the vehicle.

### BACKGROUND OF THE INVENTION

In general, an acceleration sensor is mounted in a vehicle state detecting device used for a vehicle airbag system. When an acceleration sensor is mounted in a front portion of a vehicle (e.g. in an engine room), the acceleration sensor can detect a front collision of the vehicle. When an acceleration sensor is mounted in a side portion of a vehicle (e.g. in a pillar), the acceleration sensor can detect a side collision of the vehicle. Therefore, the direction of the sensitivity axis for acceleration to be detected of an acceleration sensor is determined uniquely according to a portion to which the acceleration sensor is mounted.

Thus, although there is a demand for detection of a collision from a vehicle front side and a collision from a vehicle lateral side in an airbag system, a system which detects a rollover and a sideslip of a vehicle to provide a higher degree of safety has been proposed in recent years.

A currently used airbag system typically needs a gyro sensor (for roll rate detection) and two acceleration sensors (for detection in a rightward or leftward direction and for detection in an upward or downward direction) in order to detect a rollover of a vehicle, and needs a gyro sensor (for yaw rate detection) and two acceleration sensors (for detection in a longitudinal direction and for detection in a rightward or leftward direction) in order to detect a sideslip of the vehicle.

Therefore, in order to add a function of detecting a rollover and a sideslip to an airbag system, two gyro sensors in total and one acceleration sensor (no acceleration sensor overlappedly disposed in a detecting direction is counted) must be added to the airbag system.

On the other hand, a method of determining each acceleration from accelerations at a plurality of points can be derived from a simple physical equation, and is already known in patent reference 1, patent reference 2, and so on. Further, patent reference 3 suggests a method of correcting the inclination of a device.

### RELATED ART DOCUMENT

### Patent Reference

Patent reference 1: Japanese Unexamined Patent Application Publication No. Hei 11-295335
Patent reference 2: Japanese Unexamined Patent Application Publication No. Hei 7-72165
Patent reference 3: Japanese Patent No. 2878498

### SUMMARY OF THE INVENTION

However, in any of the devices disclosed by above-mentioned patent references 1 and. 2, a plurality of acceleration sensors each of which detects acceleration in one axis direction are mounted to a plurality of points, respectively, and a detection error occurs in each acceleration sensor when the device is mounted to a vehicle with the device being inclined with respect to the vehicle. Further, because the device disclosed by patent reference 3 makes a relative correction to the inclination of the device on the basis of movements of the vehicle, the error becomes large. A further problem is that any of the devices disclosed by above-mentioned patent references detects a direction of rotation about one axis, but does not also double as a unit for detecting a front collision, a side collision, a rollover, a sideslip, etc. of a vehicle.

The present invention is made in order to solve the above-mentioned problems, and it is therefore an object of the present invention to provide a vehicle state detecting device which can correctly detect a front collision, a side collision, etc. of a vehicle with a small number of sensors, and a vehicle state detecting system which can detect a state of a vehicle, such as a front collision or a side collision of the vehicle, without using gyro sensors.

In accordance with the present invention, there is provided a vehicle state detecting device including: an arithmetic operation unit for determining a gravity direction from a sum of vectors which are results of detection acquired by acceleration sensors respectively disposed on three axes to correct an inclination of the above-mentioned mounting, and for detecting acceleration in a longitudinal direction of the above-mentioned vehicle, acceleration in a rightward or leftward direction of the vehicle, and acceleration in an upward or downward direction of the vehicle.

In accordance with the present invention, there is provided a vehicle state detecting device in which a detecting direction of an acceleration sensor for detecting acceleration in one of three axes is oriented in a rightward or leftward direction of a vehicle, the vehicle state detecting device including: an arithmetic operation unit for determining a gravity direction from a sum of vectors which are results of detection acquired by remaining acceleration sensors disposed on the two other axes to recognize an inclination of mounting of the device in a direction of rotation on a plane defined by the above-mentioned two axes, and for detecting acceleration in a longitudinal direction of the above-mentioned, vehicle, acceleration in the rightward or leftward direction of the vehicle, and acceleration in an upward or downward direction of the vehicle.

In accordance with the present invention, there Is provided a vehicle state detecting system in which a vehicle state detecting device is mounted to each of both sides of a vehicle, the vehicle state detecting device including an arithmetic operation unit for determining a gravity direction from a sum of vectors which are results of detection acquired by acceleration sensors respectively disposed on three axes to recognize an inclination of the above-mentioned mounting, and for detecting acceleration in a longitudinal, direction of the above-mentioned vehicle, acceleration in a rightward or leftward direction of the vehicle, and acceleration in an upward or downward direction of the vehicle, or a vehicle state detecting device in which a detecting direction of an acceleration sensor for detecting acceleration in one of the three axes is oriented in the rightward or leftward direction of the vehicle, and an arithmetic operation unit for determining the gravity direction from a sum of vectors which are results of detection acquired by remaining acceleration sensors disposed on the two other axes to recognize an inclination of mounting of the device in a direction of rotation on a plane defined by the above-mentioned two axes, and for detecting acceleration in a longitudinal direction of the above-mentioned vehicle, acceleration in the rightward or leftward direction of the vehicle, and acceleration in an upward or downward direction of the vehicle is included is mounted to each of both the sides of the vehicle.

Because the vehicle state detecting device in accordance with the present invention determines the gravity direction from the sum of the vectors which are the results of detection acquired by the acceleration sensors respectively disposed on the three axes to correct the mounting inclination thereof with respect to the vehicle, the vehicle state detecting device can correctly detect the acceleration in the longitudinal direction of the vehicle, the acceleration in the rightward or leftward direction of the vehicle, and the acceleration in the upward or downward direction of the vehicle with the small number of acceleration sensors.

Further, because in the vehicle state detecting device in accordance with the present invention, the detecting direction of an acceleration sensor for detecting acceleration in one of the three axes is oriented in the rightward or leftward direction of the vehicle, and the vehicle state detecting device determines the gravity direction from the sum of the vectors which are the results of detection acquired by the remaining acceleration sensors disposed on the two other axes to correct the mounting inclination of the device with respect to the vehicle, the vehicle state detecting device can certainly detect the acceleration in the rightward or leftward direction of the vehicle by using the acceleration sensor disposed on the one of the three axes, and can also detect the acceleration in the longitudinal direction of the vehicle and the acceleration in the upward or downward direction of the vehicle correctly without being influenced by the inclination of the mounting angle in a direction of rotation with respect to the vehicle.

Further, because in the vehicle state detecting system in accordance with the present invention, the vehicle state detecting device including the acceleration sensors respectively disposed on the three axes in such a way as to be able to detect the acceleration in the direction of each of the three axes is mounted to each of both the sides of the vehicle, or the vehicle state detecting device in which the detecting direction of the acceleration sensor for detecting acceleration in the one of the three axes is oriented in the rightward or leftward direction of the vehicle, and which determines the gravity direction from the sum of the vectors which are the results of detection acquired by the remaining acceleration sensors disposed on the two other axes is mounted to each of both the sides of the vehicle, the vehicle state detecting system can detect not only the acceleration, but also the direction of rotation of the vehicle from the difference between the results of detection on both the sides of the vehicle. As a result, the vehicle state detecting system can detect such a state of the vehicle e as a rollover or a sideslip, as well as a front collision, a side collision or the like of the vehicle.

### BRIEF DESCRIPTION OF THE FIGURES

FIG. 1 is an explanatory drawing of a vehicle state detecting device in accordance with Embodiment 1 of the present invention;

FIG. 2 is a view showing a communication form in which this vehicle state detecting device outputs detection results;

FIG. 3 is an explanatory drawing of a vehicle state detecting device in accordance with Embodiment 2 of the present invention;

FIG. 4 is an explanatory drawing of a vehicle state detecting system in accordance with the present invention which uses the vehicle state detecting device shown in FIG. 1; and

FIG. 5 is an explanatory drawing of another example of the vehicle state detecting system in accordance with the present invention.

### EMBODIMENTS OF THE INVENTION

Hereafter, the preferred embodiments of the present invention will be explained in detail with reference to the drawings.

### Embodiment 1

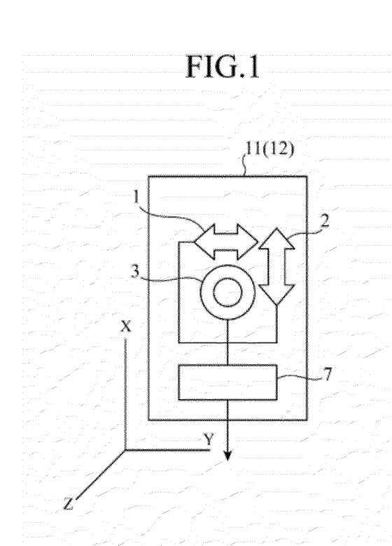

FIG. 1 is an explanatory drawing of a vehicle state detecting device in accordance with Embodiment 1 of the present invention. The vehicle state detecting device in accordance with Embodiment 1 is provided with acceleration sensors 1, 2, and 3 respectively disposed on three axes X, Y, and Z in such a way as to be able to detect acceleration in a direction of each of the three axes, and an arithmetic operation unit 7 for determining a gravity direction from the sum of vectors which are the results of detection acquired by the acceleration sensors 1, 2, and 3 respectively disposed on the three axes.

The vehicle state detecting device in accordance with this Embodiment 1 can correctly detect acceleration in a longitudinal direction of a vehicle, acceleration in a rightward or leftward direction of the vehicle, and acceleration in an upward or downward direction of the vehicle with the small number of sensors by correcting a mounting inclination of the vehicle state detecting device with respect to the vehicle by using the determined gravity direction.

At least two of the above-mentioned acceleration sensors 1, 2, and 3 can be constructed in such a way as to have the same structure so that the two acceleration sensors have similar characteristics. In this case, there is provided an advantage of reducing errors occurring when using the sum of the vectors which are the results of detection acquired by the acceleration sensors 1, 2, and 3 respectively disposed on the three axes.

The acceleration sensors 1, 2, and 3 have self-diagnostic functions independent of one another, respectively. In this case, even if a failure occurs in one of the acceleration sensors, the remaining acceleration sensors can carry out the detection on behalf of the out-of-order acceleration, and therefore a detection impossible situation due to a failure occurring in one acceleration sensor can be prevented from occurring. Because the self-diagnostic function is known well, a detailed explanation of the self-diagnostic function will be omitted hereafter.

Further, the arithmetic operation unit 7 has a function of outputting information about the mounting inclination of the vehicle state detecting device with respect to the vehicle which is determined thereby to an external device, so that the external device can reduce the burden of determining the gravity direction from the sum of the vectors which are the results of detection acquired by the acceleration sensors respectively disposed on the axes. Further, by mounting the vehicle state detecting device to the body of the vehicle in such a way that the gravity is applied to all, of the acceleration sensors 1, 2, and 3, any one of the acceleration sensors respectively disposed in the directions of the X-axis, the Y-axis and the Z-axis can have an inclination angle with respect to the gravity direction, and the vehicle state detecting device can correct the mounting inclination of the vehicle state detecting device with respect to the body of the vehicle more correctly.

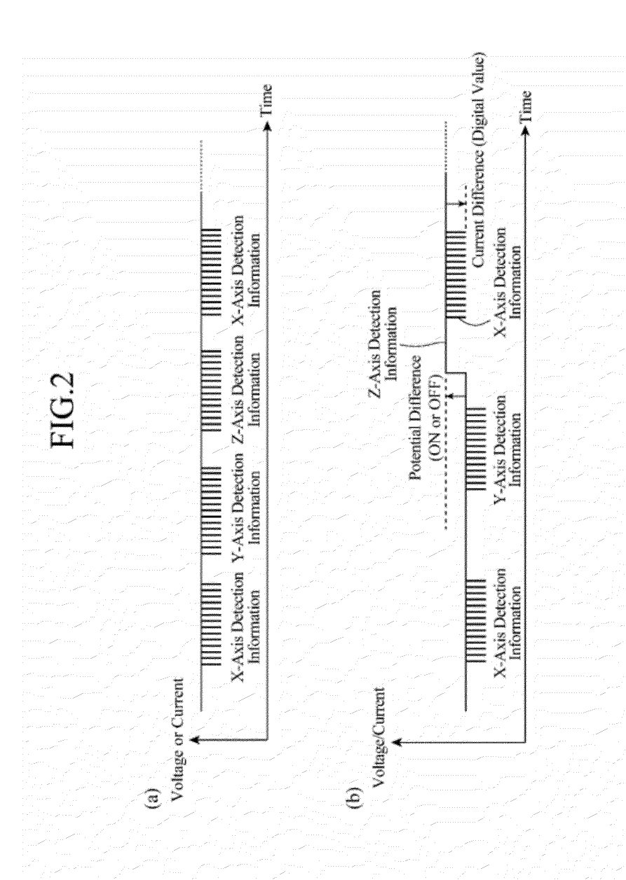

The arithmetic operation unit is constructed in such a way as to output output signals of the acceleration sensors via an identical signal line in such a way that the output signals appear on the identical signal line with a time difference from one another, as shown in FIG. 2(a), thereby being able to simplify the structure of the device. In this case, by adding an identifiable trigger signal or identifiable header information to the output signal of each of the acceleration sensors 1, 2, and 3 to output the output signal, any unit which receives the output signal is enabled to easily identify the output signal of each of the acceleration sensors 1, 2, and 3.

In addition to the acceleration sensors 1, 2, and 3 respectively arranged on the three axes X, Y, and Z, the detection results acquired by the acceleration sensors being used for the determination of the gravity direction, the vehicle state detecting device includes an acceleration sensor with a large measurement range for detecting a collision in a rightward or leftward direction of the vehicle, thereby being able to correctly output a collision in a rightward or leftward direction of the vehicle which the vehicle state detecting device desires to detect.

The arithmetic operation unit further uses either a potential difference or a current difference to output the output signal of each of the acceleration sensors 1, 2, and 3 appearing on the identical signal line, as shown in FIG. 2(b), thereby being able to carry the output signals of the plurality of acceleration sensors on the single signal line simultaneously, and simplify the structure of the device in the example illustrated in the figure, the information about the detection in the direction of the Z-axis is outputted with a potential difference at the same time when the information about the detection in the direction of the X-axis is outputted with a current difference.

### Embodiment 2

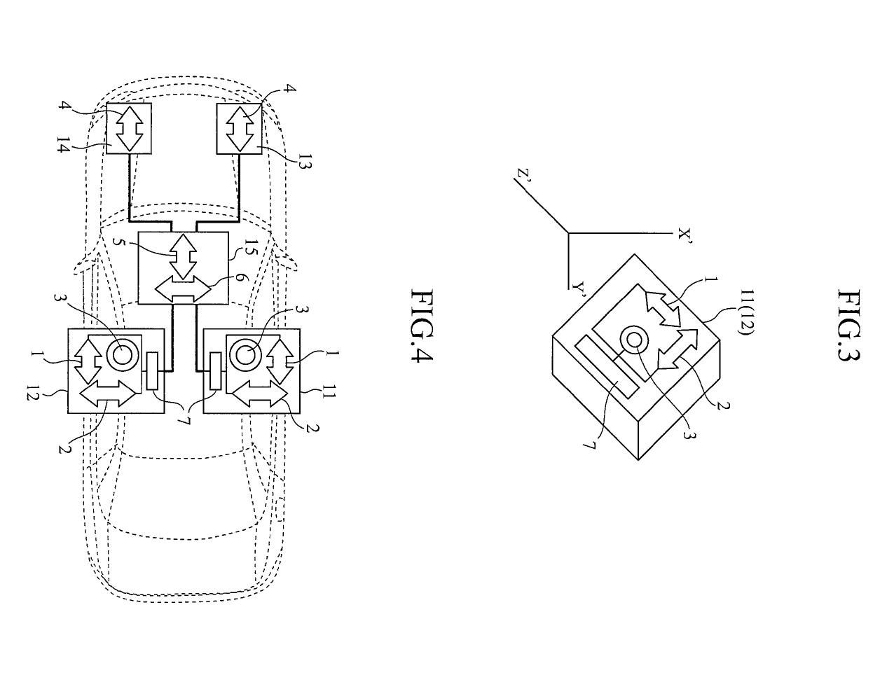

FIG. 3 is an explanatory drawing of a vehicle state detecting device in accordance with Embodiment 2 of the present invention. The vehicle state detecting device in accordance with Embodiment 2 is constructed in such a way as to include acceleration sensors 1, 2, and 3 respectively disposed on three axes X, Y, and Z in such a way as to be able to detect acceleration in a direction of each of the three axes, orient the detecting direction of the acceleration sensor 1 for detecting acceleration in one of the three axes in a rightward or leftward direction of a vehicle, and determine a gravity direction from the sum of vectors which are the results of detection acquired by the remaining acceleration sensors 1 and 3 respectively disposed on the two axes X and Z. An example illustrated in the figure is the one in which the vehicle state detecting device is mounted to the body of the vehicle with each of the acceleration sensors disposed on the X-axis and the Z-axis being inclined 45 degrees with respect to the body of the vehicle, and the acceleration of gravity in the direction of the X-axis is −0.7 G and die acceleration of gravity in the direction of the Z-axis is +0.7 G. In another example in which the vehicle state detecting device is mounted to the body of the vehicle with the acceleration sensor disposed on the Z-axis being oriented in a vertical direction, the acceleration of gravity in the direction of the Z-axis is 1 G and the acceleration of gravity in the direction of the X-axis is 0 G.

Because the vehicle state detecting device in accordance with this Embodiment 2 corrects a mounting inclination thereof by using the determined gravity direction, the vehicle state detecting device in accordance with this Embodiment. 2 can correctly detect acceleration in a longitudinal direction of the vehicle, acceleration in a rightward or leftward direction of the vehicle, and acceleration in an upward or downward direction of the vehicle without being influenced by the mounting inclination in a direction of rotation on a plane defined by the two axes.

Further, the acceleration sensor for detecting the acceleration in the longitudinal or rightward or leftward direction of the vehicle is placed in such a way that its sensitivity axis is oriented in a horizontal direction, and has a measurement range with which the vehicle state detecting device can detect a collision of the vehicle, so that the sensor oriented in a direction of a collision is placed horizontally and the need for a gravity correction is eliminated. Thus, the vehicle state detecting device can be constructed in such a way that the acceleration sensor has a measurement range suitable for the detection of a collision, and can ensure a certain degree of measurement accuracy according to each use thereof.

Further, an arithmetic operation unit 7 outputs the results of detection on the two axes which are used for the determination of the gravity direction as a calculated value after a vector synthesis. As a result, an external device can reduce the burden of determining the gravity direction from the sum of the vectors which are the results of detection acquired by the acceleration sensors respectively disposed on the axes.

### Embodiment 3

FIG. 4 is an explanatory drawing of a vehicle state detecting system in accordance with the present invention which uses vehicle state detecting devices as shown in FIG. 1. In the vehicle state detecting system, vehicle state detecting devices 11 and 12 each provided with acceleration sensors 1, 2, and 3 respectively disposed on three axes in such a way as to be able to detect acceleration in a direction of each of the three axes are mounted to both left and right sides of a vehicle, respectively, vehicle state detecting devices 13 and 14 each provided with an acceleration sensor 4 are mounted to both right and left sides of a front portion of the vehicle, respectively, and a control unit 15 provided with acceleration sensors 5 and 6 is mounted to a central portion of the vehicle.

According to the structure of this Embodiment 3, the vehicle state detecting system can detect not only acceleration of the vehicle, but also the direction of rotation of the vehicle from the difference between the detection results of the vehicle state detecting devices disposed on both the sides of the vehicle. More specifically, compared with a related art system in which a vehicle state detecting device having an acceleration sensor disposed on one axis is placed on each of both sides of a vehicle, four acceleration sensors in total are additionally disposed in the vehicle state detecting system in accordance with the present invention in which the vehicle state detecting devices 11 and 12 each provided with acceleration sensors 1, 2, and 3 respectively disposed on three axes are mounted to both the left and right sides of the vehicle, respectively. However, because the vehicle state detecting system can detect such a state of the vehicle as a rollover or a sideslip, as well as a front collision, a side collision or the like of the vehicle, by using the acceleration sensors 1 to 6 mounted in the vehicle state detecting devices 11 and 12, the vehicle state detecting devices 13 and 14 disposed in the front portion of the vehicle, and the control unit 15, the need for two gyro sensors eliminated as compared with the related art system. Further, as mentioned above, because gyro sensors are more expensive than acceleration sensors, a reduction in the system cost can be achieved by eliminating the two gyro sensors

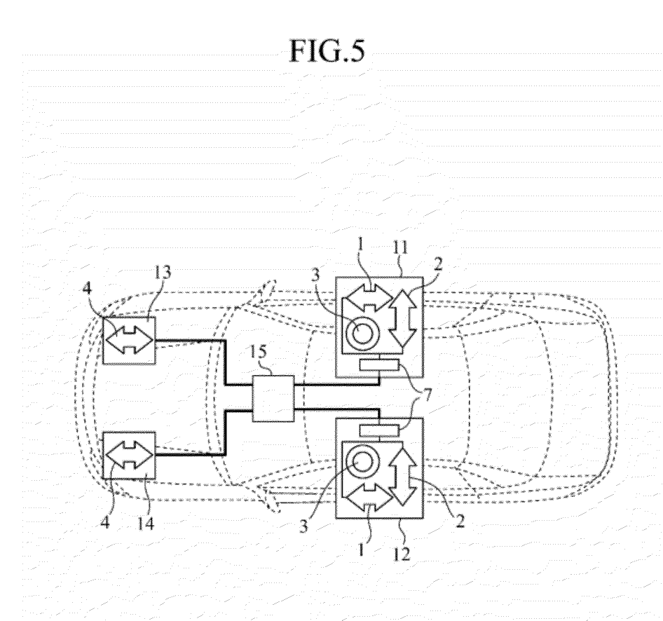

Further, while the related art system detects a collision from a front side of a vehicle by using two acceleration sensors mounted in an in-vehicle state detecting device placed in a front portion of the vehicle and a control unit placed in a central portion of the vehicle, and also detects a collision from a lateral side of the vehicle by using two acceleration sensors mounted in in-vehicle state detecting devices arranged on both sides of the vehicle, and the control unit placed in the central portion of the vehicle, the vehicle state detecting system in accordance with the present invention can detect a collision from a front side of the vehicle and a collision from a lateral side of the vehicle by using either the acceleration sensors mounted in the vehicle state detecting devices 11 and 12 in accordance with the present invention arranged on both the sides of the vehicle, and the vehicle state detecting devices 13 and 14 arranged in the front portion of the vehicle, or the acceleration sensors mounted in the vehicle state detecting devices 11 and 12 arranged on both the sides of the vehicle. Therefore, the two acceleration sensors 5 and 6 mounted in the control unit 15 and used for detection of a front collision and for detection of a side collision can be eliminated, as shown in FIG. 5.

Further, in this structure shown in FIG. 5, because there is no necessity to mount any gyro sensor and any acceleration sensor at all in the control unit 15, the case structure of the control unit 15 which provides adequate rigidity in order to cause these acceleration sensors to correctly operate can be simplified. In addition, the constraint on the installation location of the control unit 15 that the control unit must be placed on a floor at the center of the vehicle which provides adequate rigidity from the viewpoint of acceleration propagation and measurement of a rotation angle can be removed.

Further, because the vehicle state detecting devices 11 and 12 in each of which an acceleration sensor exists in each axis direction are disposed on both the sides of the vehicle in any of the structures shown in FIGS. 4 and 5, the vehicle state detecting system can calculate acceleration in a direction of each of the three axes on each of both the sides of the vehicle to detect the state of the vehicle. Thus, the vehicle state detecting system can be formed into a dual system.

As mentioned above, the vehicle state detecting system which can detect a head-on collision, a side collision, rollover, and a sideslip of a vehicle can reduce the required number of acceleration sensors by two gyro sensors and two acceleration sensors by using vehicle state detecting devices in accordance with the present invention as compared with the related art system, as shown in the following table. The vehicle state detecting system has also many merits of achieving a simplification of the case structure of the control unit 15, and improving the flexibility of the location in the vehicle to which the control unit is mounted.

| | | TABLE | |
|---|---|---|---|
| | | Number of Sensors | |
| Object to Be | | Related | Present |
| Detected | Needed Sensor Type | Art | Invention |
| Head-on | Acceleration Sensor | 3 | 4 |
| Collision | (Longitudinal Direction) | | |
| Side | Acceleration Sensor | 3 | 2 |
| Collision | (Rightward or Leftward Direction) | | |
| Rollover | Gyro Sensor (Roll Rate) | 1 | Needlessness |
| | Acceleration Sensor | Double | Double Use |
| | (Rightward or Leftward Direction) | Use | |
| | Acceleration Sensor | 1 | 2 |
| | (Upward or Downward Direction) | | |
| Sideslip | Gyro Sensor (Yaw Rate) | 1 | Needlessness |
| | Acceleration Sensor | Double | Double Use |
| | (Longitudinal Direction) | Use | |
| | Acceleration Sensor | Double | Double Use |
| | (Rightward or Leftward Direction) | Use | |

| | | |
|---|---|---|
| Total Number of Sensors | 9 | 8 |

In the example illustrated in the figure, although the structure in which the arithmetic operation unit 7 is disposed in the vehicle state detecting device 11 or 12 is shown, this arithmetic operation unit 7 can be alternatively disposed in the control unit 15. In this case, output signals of the acceleration sensors 1, 2, and 3 of the vehicle state detecting device 11 or 12 are transmitted to the control unit 15 according to a communication form shown in FIG. 2(a) or 2(b).

### INDUSTRIAL APPLICABILITY

The present invention is effective for an airbag system which is mounted in a vehicle.

1. A vehicle state detecting device provided with acceleration sensors respectively disposed on three axes in such a way as to be able to detect acceleration in each of directions of three axes, and mounted to a vehicle, said vehicle state detecting device comprising:
an arithmetic operation unit for determining a gravity direction from a sum of vectors which are results of detection acquired by said acceleration sensors to correct an inclination of said mounting, and for detecting acceleration in a longitudinal direction of said vehicle, acceleration in a rightward or leftward direction of said vehicle, and acceleration in an upward or downward direction of said vehicle,
said vehicle state detecting device being mounted to each of both left and right sides of the vehicle, and performing an arithmetic operation on the acceleration in each of the directions of the three axes which is detected on each of both the left and right sides of the vehicle to detect a state of the vehicle.

2. The vehicle state detecting device according to claim 1, wherein at least two of the acceleration sensors respectively disposed on the three axes in such a way as to detect the acceleration in each of the directions of the three axes have a same structure.

3. The vehicle state detecting device according to claim 1, wherein the acceleration sensors respectively disposed on the three axes in such a way as to detect the acceleration in each of the directions of the three axes have self-diagnostic functions independent of one another.

4. The vehicle state detecting device according to claim 1, wherein the arithmetic operation unit has a function of outputting information about the gravity direction determined thereby to outside said arithmetic operation unit.

5. The vehicle state detecting device according to claim 1, wherein each of the three axes has an inclination angle with respect to the gravity direction.

6. The vehicle state detecting device according to claim 1, wherein the arithmetic operation unit outputs output signals of the acceleration sensors via an identical signal line in such a way that the output signals appear on the identical signal line with a time difference from one another.

7. The vehicle state detecting device according to claim 1, wherein the arithmetic operation unit outputs output signals of the acceleration sensors while adding an identifiable trigger signal or identifiable header information to each of the output signals.

8. The vehicle state detecting device according to claim 1, wherein the vehicle state detecting device additionally includes an acceleration sensor capable of detecting a collision in a rightward or leftward direction of the vehicle.

9. The vehicle state detecting device according to claim 1, wherein the arithmetic operation unit uses either a potential difference or a current difference to output an output signal of each of the acceleration sensors.

10. The vehicle state detecting device according to claim 1, wherein the arithmetic operation unit outputs the results of detection on the three axes from which to determine the gravity direction as a calculated result after a vector synthesis.

11. A vehicle state detecting device provided with acceleration sensors respectively disposed on three axes in such a way as to be able to detect acceleration in each of directions of the three axes, and mounted to a vehicle, wherein a detecting direction of an acceleration sensor for detecting acceleration in one of the three axes is oriented in a rightward or leftward direction of the vehicle, and said vehicle state detecting device comprises: an arithmetic operation unit for determining a gravity direction from a sum of vectors which are results of detection acquired by remaining acceleration sensors disposed on the two other axes to correct an inclination of mounting of the device in a direction of rotation on a plane defined by said two axes, and for detecting acceleration in a longitudinal direction of said vehicle, acceleration in the rightward or leftward direction of said vehicle, and acceleration in an upward or downward direction of said vehicle.

12. The vehicle state detecting device according to claim 11, wherein the acceleration sensor for detecting the acceleration in the longitudinal direction of the vehicle and the acceleration sensor for detecting the acceleration in the rightward or leftward direction of the vehicle are arranged in such a way that their sensitivity axes are horizontal to the vehicle.

13. The vehicle state detecting device according to claim 11, wherein the arithmetic operation unit outputs the results of detection on the two axes from which to determine the gravity direction as a calculated result after a vector synthesis.

14. A vehicle state detecting system in which the vehicle state detecting device according to claim 11 is mounted to each of left and right sides of a vehicle.

15. The vehicle state detecting system according to claim 14, wherein the vehicle state detecting system detects a state of the vehicle by calculating acceleration in each of directions of three axes detected on each of the both sides of the vehicle.
